(19) United States
(12) Patent Application Publication
(10) Pub. No.: US 2004/0234360 A1
(43) Pub. Date: Nov. 25, 2004

(54) System for conveying and transferring semiconductor or liquid crystal wafer one by one

(76) Inventor: Takehide Hayashi, Tokyo (JP)

Correspondence Address: Bacon & Thomas, 4th Floor, 625 Slaters Lane, Alexandria, VA, 22314-1176, US

(21) Appl. No.: 10/480,249

(22) PCT Filed: Jun. 14, 2002
(86) PCT No.: PCT/JP02/05939

(30) Foreign Application Priority Data
Jun. 25, 2001 (WO) PCT/JP01/05409
Sep. 12, 2001 (JP) 2001-319951

(51) Int. Cl. B65G 1/00

(52) U.S. Cl. 414/217

(57) ABSTRACT

A special EFEM (2) is installed in front of each of about 12 to 20 manufacturing apparatuses in a bay (in the process) of a semiconductor manufacturing factory or a liquid crystal manufacturing factory. The EFEMs are interconnected through a clean tunnel (1) and continuous traveling single-wafer conveyors (15), thus constituting interconnected EFEMs. A repacking station (3) for packing wafers in a FOUP (12) and picking up a single wafer is provided near a corner of one of the interconnected EFEMs and connected to a bay-to-bay small-batch conveyor (5). In each of the interconnected EFEMs constituting a minimum clean zone, a robot (20) having a hand with wafer-rotating mechanism is disposed so as to position a wafer and to read the bar code on a wafer. Since the robot can transfer a wafer very fast and a single-wafer conveyor conveys more than 1,000 wafers per hour, a production system with little wafer waiting time is realized.

### TECHNICAL FIELD

The present invention relates to a special equipment front end module (EFEM), feeding and transferring of wafers and a method of reading a wafer number, which achieve rationalization such as reduction of a manufacturing period, reduction of a stock in process and the like by structuring a transfer equipment in a type of being connected by a clean tunnel, that is, the EFEM, and feeding and transferring the wafers sheet by sheet, for supplying and taking out the wafers to and from a manufacturing apparatus in a semiconductor manufacturing process or a liquid crystal manufacturing process, in place of using a cassette normally including twenty five sheets or a closed box (FOUP).

### BACKGROUND ART

In conventional, handling way of feeding wafers in a pretreatment process in a semiconductor manufacturing plant is such that the wafers are put in the cassette for twenty five sheets or the closed box (FOUP) as shown in FIG. 15, and are supplied to and taking out from the manufacturing apparatus. Accordingly, it is necessary that a first wafer in the twenty five wafers in the cassette waits within the FOUP or the like until the remaining twenty four wafers are processed. It is necessary that all the wafers keep waiting until the other wafers within the FOUP is processed. The wafers waiting for being processed are generated as a stock in process in all the manufacturing apparatuses for the semiconductor and the liquid crystal which are constituted by one hundred or more manufacturing apparatuses for five hundreds or more steps. In accordance with this method, a waiting time until being processed, and thus the materials in process are increased. Further, it is necessary to provide a mechanism for taking out the wafer from the FOUP and for supplying another wafers into the apparatus after processing in the manufacturing apparatus. Further, in order to automatically feed and automatically stores the cassette and the FOUP, a large space and an expensive physical distribution system are required in correspondence to the size and the weight of the cassette and the FOUP. On the other hand, since the wafer size is increased in diameter for the purpose of improving a production efficiency, the size and the weight of the cassette and the FOUP are one of reasons of increasing a cost for constructing a clean room plant requiring a high cost investment. The present invention relates to a system of having wafers moved singly between the manufacturing apparatuses by continuously feeding the wafers sheet by sheet in a minimum clean area, and thus compensates a defect in the conventional art to particularly realize the sheet by sheet manufacturing.

The semiconductor and the liquid crystal wafer are changed from the diameter of 200 mm to the diameter of 300 mm, the manufacturing apparatus in correspondence to the diameter of 300 mm is mostly changed from a batch processing system in the generation of 200 mm to a sheet by sheet processing system, and it is an industry target to increase a production efficiency by making the manufacturing apparatus and the feeding to be in the sheet by sheet system. For example, IBM announced the system of feeding the semiconductor wafer in a state of the semiconductor wafer being floated on the basis of air pressure called as QTAT in EAST FISHKILL plant, however, this system has an objection in view of static electricity and feed and transfer on the basis of a strong air flow even when the wafer is floated. Accordingly, it is impossible to satisfy a specification of an actual line in which it is necessary to feed 500 to 1000 sheets of wafers per hour, and this system has not actually operated. Further, as a similar system, there has been conventionally an equipment for feeding the wafer between the apparatuses by a conveyor. For example, in JP3-154751A, there is shown a method relating to transfer performed by a loop-type convey or and a robot. However, that method corresponds to a method of handling per unit of cassette, and gripping the cassette by the robot, and further, it is necessary that the robot has a traveling function at a time of transferring the cassette to the side of the apparatus. This system is different from the present invention in which the wafers are transferred per unit of sheet by only an end surface of the wafer being held, and does not intend to shorten the time of the manufacturing process while avoiding the wafers being once stocked in the cassette.

Further, there is a method of feeding the wafer between the apparatuses by using a belt in accordance with the conventional art. This method is shown, for example, in U.S. Pat. No. 5,820,679A and JP7-122622A. In those documents, a method of transferring between the conveyor and the apparatus is not clearly described, however, the conveyor receives a bottom surface of the wafer by the belt, and a dust is generated due to friction between the wafer and the belt, so that it is impossible to satisfy an up-to-date specification required for manufacturing the wafer, that is, the bottom surface of the wafer should not be in contact as much as possible. Further, these documents does not show an idea of minimizing the clean area required for producing the semiconductor and the liquid crystal. Further, there is no concept of connection type EFEM by which the manufacturing period is speeded up by connecting many EFEMs by the clean area and feeding the wafers sheet by sheet. It is extremely important for reducing an amount of capital investment of the clean plant and a running cost that feeding between the manufacturing apparatuses is made within the minimum clean area. The present invention realizes a reduction of production time (quick turn around time) and a reduction of materials in process and an inventory of finished goods by achieving the sheet by sheet feeding by means of the connection type EFEM in the semiconductor manufacturing or the liquid crystal manufacturing.

### DISCLOSURE OF THE INVENTION

A connection type EFEM corresponding to a main portion of the present invention is constituted by the following four structure elements. In front of each of manufacturing apparatuses for a semiconductor and a liquid crystal, there are arranged a special equipment front end module (EFEM) 10 constituted by a robot 2, an FOUP 12 and an FOUP opener 14, a clean tunnel 1 having a common clean area with the special EFEM 2, a sheet conveyor 15 continuously feeding wafers 16 within the clean tunnel, and a refilling station 3 refilling the semiconductor wafers or the liquid crystal wafers to the FOUP (a normal EFEM is referred by FIG. 14). The connection type EFEM structured such that a group of EFEMs are connected by these four structures is in contact with the outside of the connection type EFEM by the refilling station 3 for refilling the wafers 16 to the FOUP 12. The wafers 16 are fed and transferred sheet by sheet within the connection type EFEM, and the wafers 16 are fed and transferred per unit of the FOUP 12 in the outside of the connection type EFEM. The wafers 16 within the FOUP 12 are made into loose sheets or refilled to the FOUP 12 by a robot 20 in the wafer refilling station 3, which is a contact point between a unit of the single wafer 16 and a unit of the FOUP 12, the wafer refilling station is installed in a buffer station 4 temporarily storing the filled and empty FOUP 12, and the buffer station 4 is connected to a small batch feeder 5 for feeding between the connection type EFEMs.

The special EFEM 2 is provided with the wafer transferring robot 20, a bar code and alphameric character set reading device 25, an automatic operation buffer cassette 13, a manual operation FOUP 12 and an FOUP opener 14, and connects the clean area by the clean tunnel 1 (refer to a diagonal line portion in FIG. 1).

The robot 20 within the special EFEM 2 is provided with a holding portion 22 holding only an outer peripheral edge portion of the wafer 16, and transfers among the sheet conveyor 15, the manufacturing apparatuses 50-54, the buffer cassette 13 and the FOUP 12.

The sheet conveyor 15 is formed in a loop shape, and is of a continuous traveling type driven by a conveyor belt 38, and a finger 23 for mounting the wafer 16 at a fixed interval is mounted to a block 37 on an LM guide rail 36. Since an elongation is generated in the conveyor belt 38 after an elapse of a certain period, a take-up mechanism 17 for tightening the conveyor belt 38 and an adjusting rail replacement portion 18 are provided in a part of the LM guide rail 36 (FIGS. 16 and 17). In the case that the conveyor belt 38 is elongated, it is replaced with the adjusting LM guide to which the elongated size is added. The holding portion 24 for minimizing the contact with the wafer 16 is mounted to the finger 23 of the sheet conveyor 15, and only the outer peripheral edge portion of the wafer 16 is held. In order to prevent the dust generated in accordance with the driving of the sheet conveyor 15 from being affected to a clean degree within the clean tunnel 1, the conveyor is structured such that a clean countermeasure is obtained by mounting an exhaust fan 31 for making the inside of the sheet conveyor 15 negative pressure, connecting the exhaust fan 31 to an exhaust duct 32 and discharging air via air filter.

Since it is hard that a manufacturing engineering system (MES) corresponding to a computer for controlling a production in a semiconductor plant or a liquid crystal plant tracks all the wafers with no mistake, it is most desirable to read the wafer number before supplying the wafers 16 to the manufacturing apparatuses 50-54, that is, at a time when the robot 20 within the special EFEM 2 scoops the wafer 16 from the sheet conveyor 15, report the fact that the wafer is correct to MES, and align a direction of the wafer 16 with a position of an apparatus stage 19 determined by the manufacturing apparatuses 50-54 so as to transfer the wafer 16. In order to satisfy the present specification, a robot hand 21 is provided with a mechanism of holding the outer peripheral edge portion of the wafer 16, rotating the wafer 16 during a transferring motion of the robot hand 21, detecting a V notch or an oriental flat so as to stop the wafer 16, and reading an alphameric character set and a bar code at a predetermined position.

### BRIEF DESCRIPTION OF THE DRAWINGS

FIG. 1 is a plan view showing a relation between a connection type EFEM and a peripheral equipments;

FIG. 2 is a cross sectional view of the connection type EFEM;

FIG. 3 is a plan view of a special EFEM;

FIG. 4 is a cross sectional view of the special EFEM;

FIG. 5 is a detailed plan view of a sheet conveyor and a robot;

FIG. 6 is a detailed cross sectional view of the sheet conveyor and the robot;

FIG. 7 is a detailed cross sectional view of a roller type sheet conveyor and a sheet robot;

FIG. 8 is a side view of a hand portion rotating mechanism of the robot and a reading apparatus;

FIG. 9 is a plan view of a wafer rotating mechanism type I;

FIG. 10 is a cross sectional view of the wafer rotating mechanism type I;

FIG. 11 is a plan view of a wafer rotating mechanism type II;

FIG. 12 is a cross sectional view of the wafer rotating mechanism type II;

FIG. 13 is a cross sectional view of a multistage type conveyor and a multistage type sheet robot for feeding and transferring a plurality of wafers;

FIG. 14 is a plan view of the EFEM;

FIG. 15 shows an FOUP;

FIG. 16 is a cross sectional view of the sheet conveyor;

FIG. 17 shows a take-up portion of the sheet conveyor;

FIG. 18 is a flow chart; and

FIG. 19 shows a calculation of stock cost.

### DESCRIPTION OF REFERENCE NUMERALS

1 clean tunnel

2 special EFEM

3 refilling station

4 buffer station

5 small batch feeder

6 HEPA filter

11 EFEM

12 FOUP

13 buffer cassette

14 FOUP opener

15 sheet conveyor main body

15′ roller type conveyor main body

16 wafer

17 take-up mechanism

18 adjusting rail replacement portion

19 apparatus stage

20 robot main body

21 robot hand

22 wafer holding portion of robot hand

23 finger of conveyor

24 holding portion on finger

25 wafer bar code and alphameric character set reading apparatus

26 support of reading apparatus

27 base portion of arm

28 pallet

29 drive roller

30 lift type stopper

31 exhaust fan

32 exhaust duct

33 hand rotating mechanism

34 multistage type conveyor finger

35 multistage type robot hand

36 LM guide rail

37 block

38 conveyor belt

40, 40′ rotation driving roller

41, 42, 41′, 42′, 43′, 44, free roller

50, 51, 52, 53, 54 manufacturing apparatus

### BEST MODE FOR CARRYING OUT THE INVENTION

In order to describe the present invention in detail, the present invention is described in accordance with the accompanying drawings.

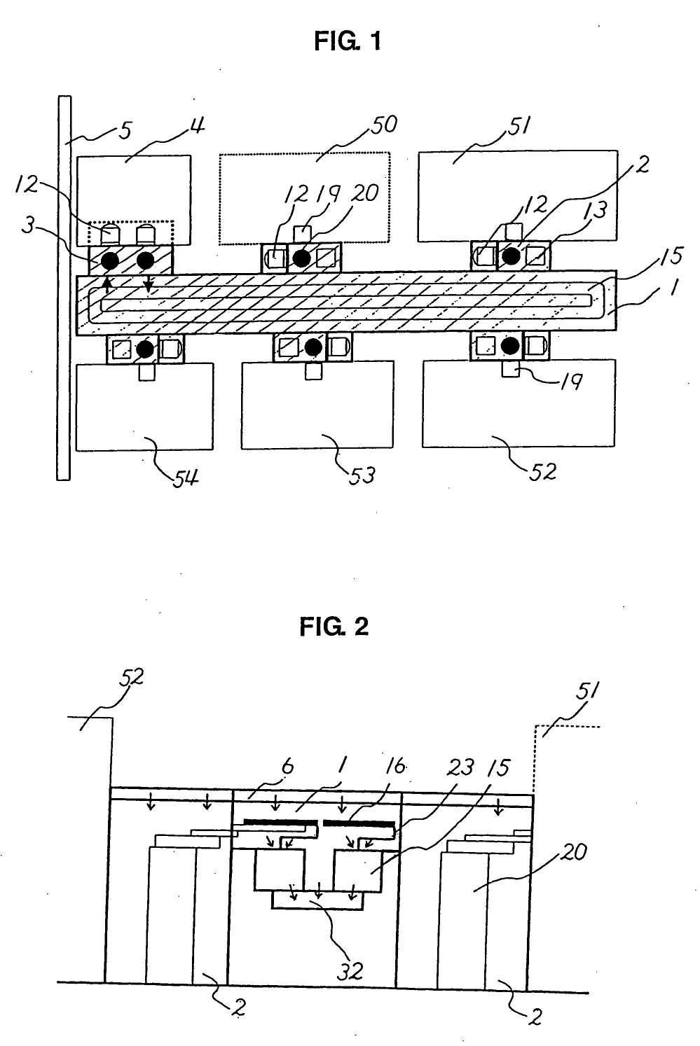

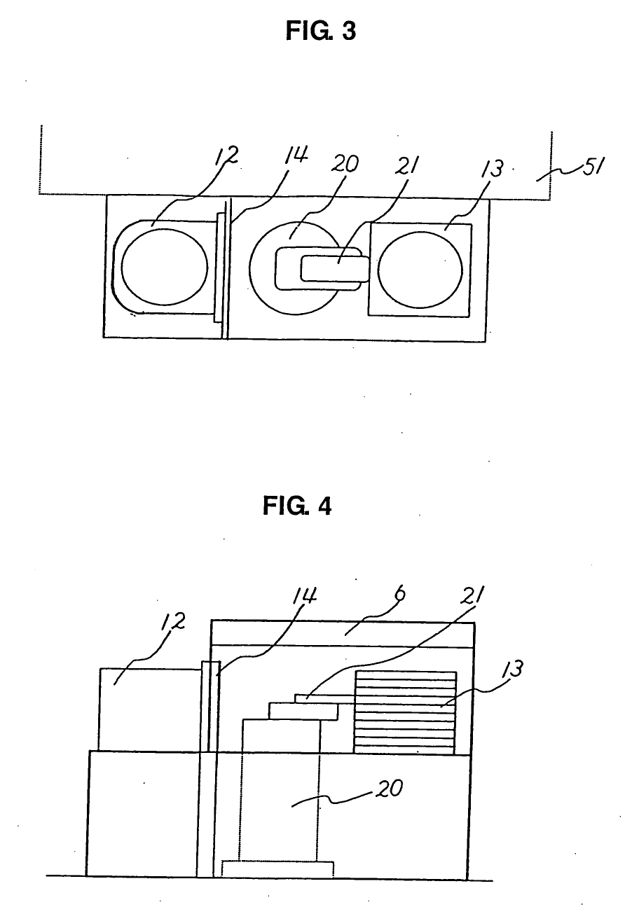

FIGS. 1 and 2 show a relation among a connection type EFEM, a buffer station 4 and a small batch feeder 5, and FIGS. 3 and 4 show a special EFEM 2. The special EFEM 2 in front of a semiconductor manufacturing apparatus or a liquid crystal manufacturing apparatus normally belongs to a super clean area of class 1 in a clean degree and a clean area of about class 1000, and the class 1 section is provided with a transferring robot 20 and a buffer cassette 13. The about 1000 class section is provided with an FOUP 12, which is provided for the purpose that an operator manually feeds the FOUP when a failure is generated in a feeding system and when a special emergency process is required in the semiconductor manufacturing apparatus or the liquid crystal manufacturing apparatus, and is not used at a time of a normal automatic operation. Further, all the normal EFEM (FIG. 14) is processed per unit of the FOUP, and the special EFEM 2 in accordance with the present invention is different from the normal EFEM in a point that the special EFEM 2 corresponds to both the buffer cassette 13 and the FOUP 12.

The special EFEM 2 and the wafer refilling station 3 are connected to the clean tunnel 1 so as to constitute the section of class 1 in the clean degree, and all the wafers 16 are fed and transferred sheet by sheet in the section of class 1 in the clean degree including the apparatus stage 19. The wafers 16 are refilled to the FOUP 12 only via the wafer refilling station 3 except the case of being manually operated for the emergency process, and the wafers 16 are put in FOUP and made to be loose sheets only at one position of the refilling station 3, thereby structuring the connection type EFEM with the special EFEMs 2 being connected.

The wafers in the FOUP 12 fed by the small batch feeder 5 on the basis of an instruction of a process controlling computer are made to be loose sheets by the robot 20 in the wafer refilling station 3 so as to be mounted on the sheet conveyor 15, however, in the case that the feeding timing does not meet with the manufacturing apparatuses 50-54, the FOUP 12 is once stored in the buffer station 4 and is transferred to the refilling station 3 from the buffer station 4 at a time when a suitable state for the manufacturing apparatuses 50-54 is achieved on the basis of the instruction of the controlling computer, thereby the wafers are made to be loose sheets and fed to the manufacturing apparatuses 50-54 by the sheet conveyor 15. The wafer 16 mounted on the sheet conveyor 15 is temporarily placed in the buffer cassette 13 by the robot 20 within the special EFEM 2 in front of the predetermined manufacturing apparatuses 50-54 or is supplied to the manufacturing apparatus stage 19. The wafer 16 having been processed by the manufacturing apparatus 50-54 is mounted on the sheet conveyor 15 by the robot 20 and is fed to the next apparatus 50-54.

Since the connection type EFEM is in contact with ten or more semiconductor manufacturing apparatuses or liquid crystal manufacturing apparatuses, a feeding capacity for feeding about 500 to 1000 sheets per hour is required, for the sheet conveyor 15. The sheet conveyor 15 in accordance with the present invention can feed 1200 sheets per hour in the case that the finger pitch is 500 mm and the conveyor speed is 10 m/min, and the capacity can be further increased.

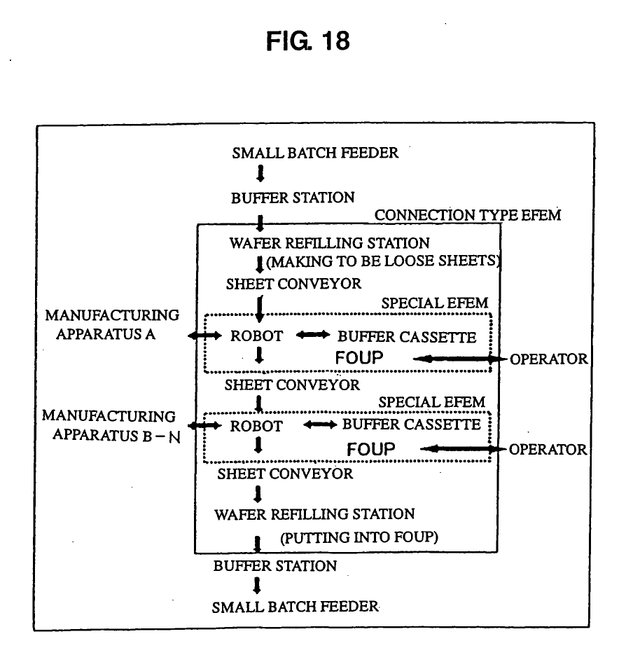

Further, the wafers 16 fed to the refilling station 3 from the special EFEM 2 can be refilled to the FOUP 12 in there filling station 3, and a timing for refilling and sending the wafers 16 can be set to an optional small batch. For example, when a determined time has passed or a determined sheet number is achieved, a lid of the FOUP 12 is automatically closed and the FOUP 12 is automatically sent to another connection type EFEM by the small batch feeder 5. Since an effect of sheet feeding can be reduced by batch feeding between the connection type EFEMs even in the case of feeding sheet by sheet within the connection type FEEM so as to avoid a waiting time for the wafer process, the feeding is executed little by little by setting a time and a sheet number for making the small batch. As a result, in the case of feeding between the connection type EFEMs by the sheet conveyor at a speed of 10 m to 15 m per minute, twenty to thirty minute is required for one circuit in the plant having a length of 150 m, however, since the small batch feeder 5 can output a speed of 150 m per minute, two minutes is sufficient for one circuit, so that the effect of sheet feeding within the connection type EFEM is not reduced. An entire flow is as shown in FIG. 18.

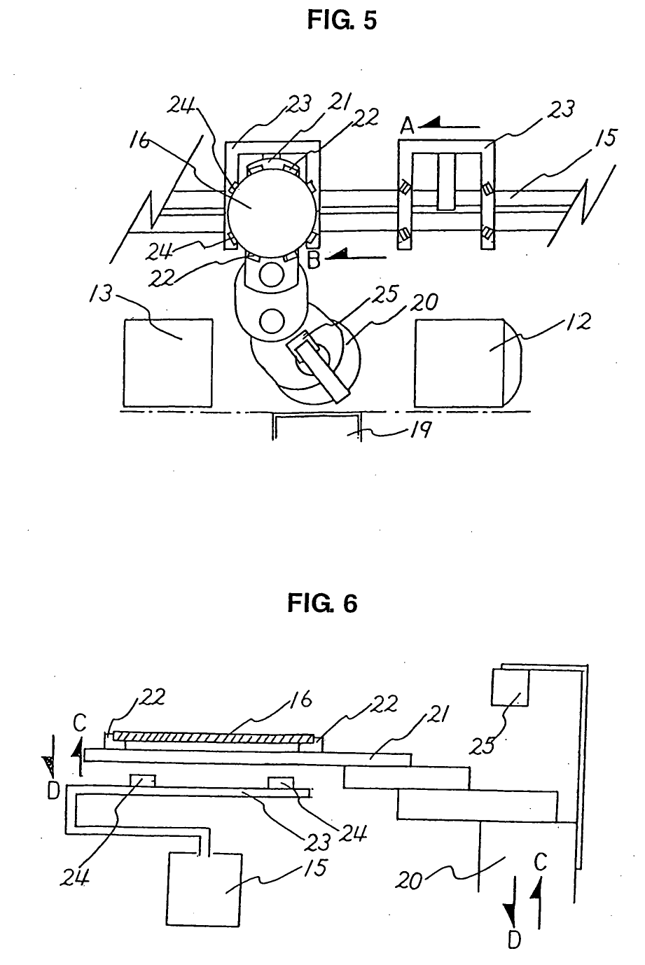

FIGS. 5 and 6 show relation of motion that the wafer 16 fed by the sheet conveyor 15 is supplied to and taken out from the manufacturing apparatuses 50-54.

The sheet conveyor 15 is a continuous traveling type conveyor which is driven in a direction A by a loop-shaped conveyor belt 38. When the wafer 16 mounted on four holding portions 24 of the finger 23 in the sheet conveyor 15 reaches in front of the predetermined manufacturing apparatus 50-54, the robot hand 21 moves below the finger 23 while being synchronized with a traveling speed of the sheet conveyor 15 moving in the direction A, and the robot main body 20 ascends in a direction C in a state in which a speed of the robot hand 21 in a direction B and the speed of the finger 23 in the direction A are met same, whereby the wafer 16 is mounted to four holding portions 22 on the robot hand 21. When mounting the wafer 16 on the conveyor, the empty finger 23 reaches a predetermined position of the manufacturing apparatus, and the robot hand 21 mounting the wafer 16 on the holding portion 22 moves in the direction B above the finger 23 moving in the direction A in synchronous with the finger so as to make the motions A and B at the same speed, and then the robot hand 21 descends in a direction D so as to transfer.

The V notch or the oriental flat of the wafer 16 has been positioned, and the bar code and the alphameric character set described on the wafer 16 have been read conventionally via a rotary wafer positioning dedicated apparatus (an aligner) and a number reading apparatus placed near the robot. However, since the rotary mechanism is assembled in the robot hand 21 so as to omit the transferring, it is possible to shorten the working time. In this case, in both of the time of scooping the wafer 16 from the sheet conveyor 15 and the time of mounting on the sheet conveyor 15 after finishing the work in the manufacturing apparatuses 50-54, the wafer number reading apparatus 25 mounted on the robot 20 can read the alphameric character set and the bar code described on the wafer 16. At a time of positioning and reading the wafer 16, the rotary mechanism installed in the robot hand 21 is utilized. Further, the transfer of the wafer 16 is performed by a method by which the area in contact with the wafer 16 is small and the damage of the wafer 16 is least, that is, the outer peripheral edge portion of the wafer 16 is held via the holding portion 24 of the sheet conveyor finger 23 and the holding portion 22 of the robot hand.

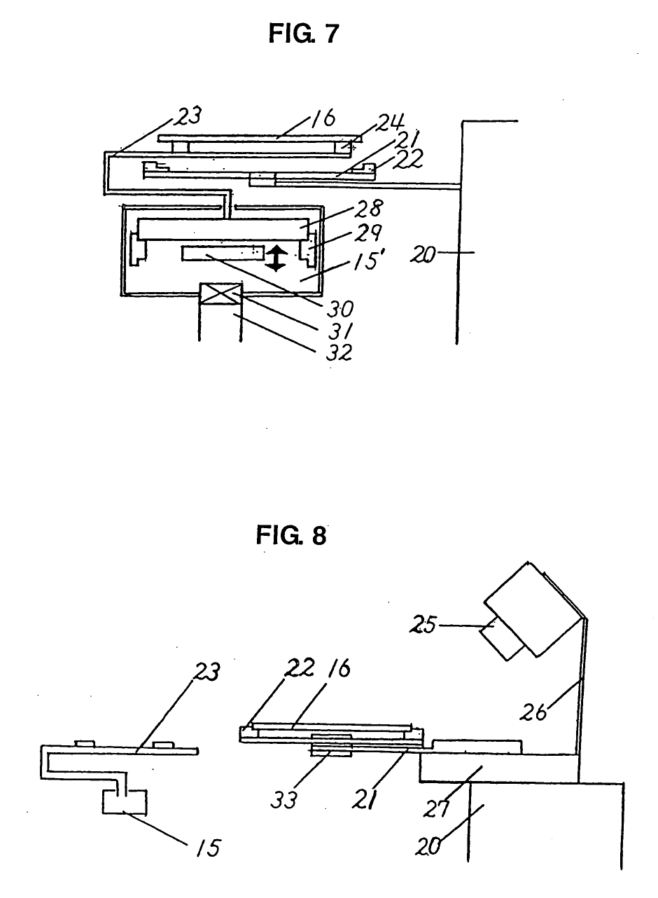

FIG. 7 shows a method of temporarily stopping the finger 23 of the conveyor in front of the apparatus stage 19 with respect to the continuously traveling type conveyor shown in FIGS. 4 and 5. The finger 23 is mounted to the pallet 28, and is traveled by the driving roller 29. When the pallet 28 reaches a predetermined position, a lift type stopper 30 ascends, whereby the pallet 28 is stopped. At the same time of the stop, the robot hand 21 moves below the wafer 16, and scoops the wafer 16 by ascending. Since the lift type stopper 30 descends at a time of scooping, the pallet 28 again travels in accordance with an operation of the driving roller 29. In the case of placing the wafer 16 on the finger 23, the operation of the pallet 28 is the same, and the operation of the robot 20 is the same as the description in FIGS. 4 and 5. In this pallet stopping method, a driving roller with an accumulation function is used, and the same function can be achieved by operating a striking stop type stopper. The exhaust fan with filter 31 and the exhaust duct 32 are mounted so as to prevent the dust from coming out of the roller conveyor main body 15′ in common with the sheet conveyor 15 of the continuously operated type.

In the case of a system of reading the bar code and the alphameric character set of the wafer 16 in front of the manufacturing apparatuses 50, 51, 52, 53 and 54 and communicating to a production controlling computer (MES), a mechanism for rotating the wafer 16 is mounted to the robot hand 21.

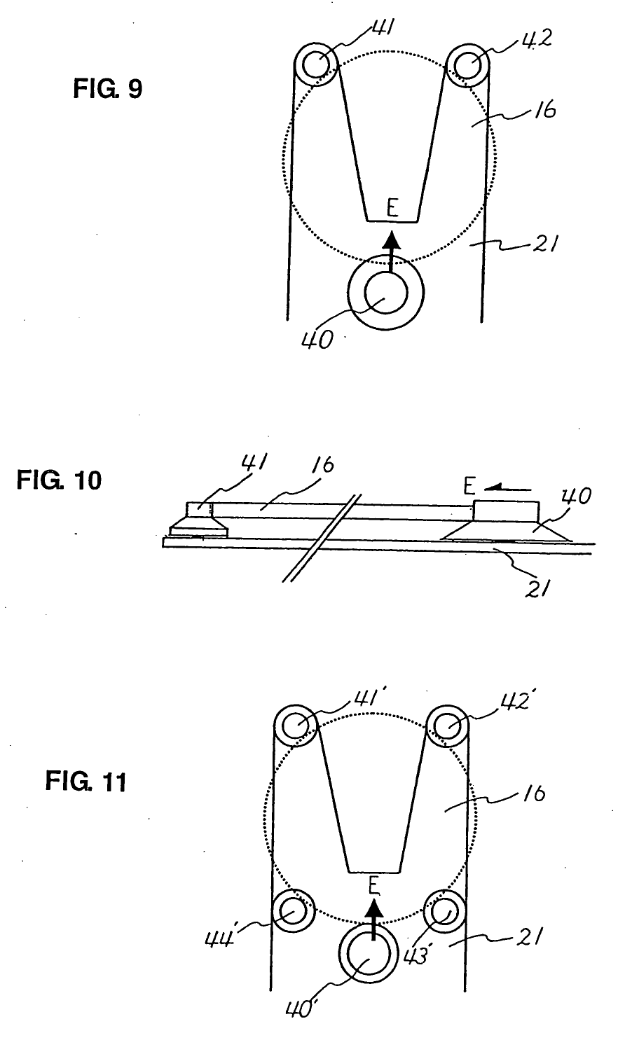

FIG. 8 shows the sheet robot 15, the wafer number reading apparatus and the rotary mechanism of the robot hand 21. The robot 20 is of a type of rotating the rotary hand 33 in a leading end portion of the hand while holding the wafer. FIGS. 9 and 10 shows two kinds of wafer rotating types on the robot hand 21. These two kinds have the same function.

A type I in FIGS. 9 and 10 operates the robot hand 21 in synchronous with the speed of the finger 23 of the traveling sheet conveyor 15, receives the outer peripheral edge portion of the wafer 16 by the robot hand 21 in inclined surface portions of a rotation driving roller 40 and free rollers 41 and 42, moves the rotation driving roller 40 in a direction E while rotating, and clamps the wafer 16 between vertical portions of the free rollers 41 and 42 and a vertical portion of the rotation driving roller 40.

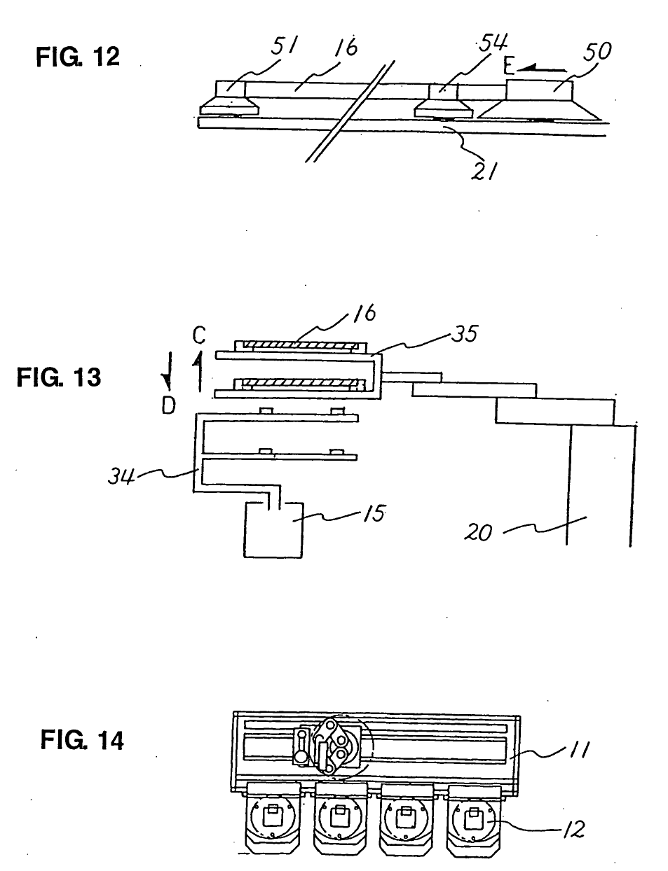

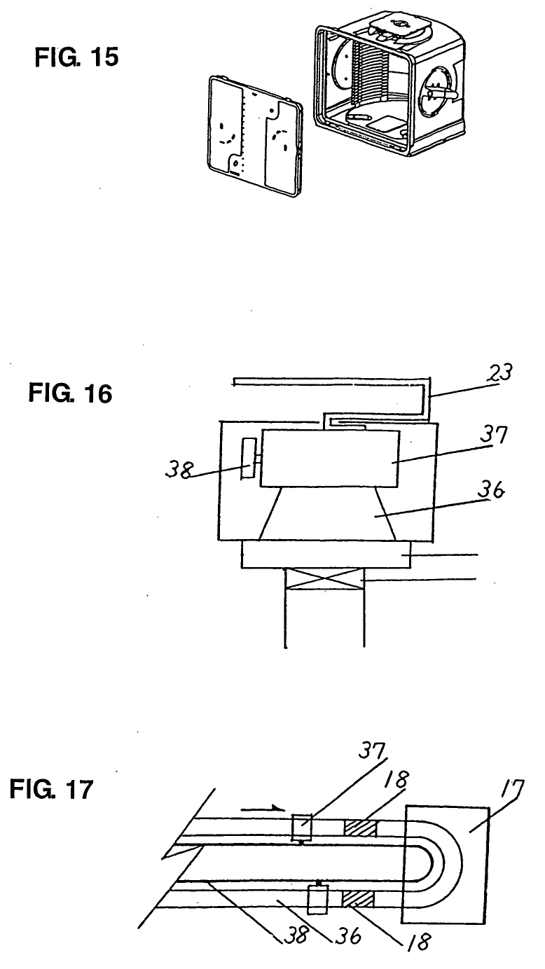

A type II in FIGS. 11 and 12 receives the outer peripheral edge portion of the wafer 16 by four free rollers 41′, 42′, 43′ and 44′, and moves a rotation driving roller 40′ in a direction E so as to clamp the wafer 16. In both types, the rollers 40, 41 and 42 or 40′, 41′, 42′, 43′ and 44′ clamp the wafer 16 while rotating, whereby the wafer 16 climbs up the inclined portion of the roller while rotating. Accordingly, it is possible to prevent the friction of the wafer 16. Further, an error in the transfer distance between the conveyor finger 23 and the rollers 40, 41 and 42 or 40′, 41′, 42′, 43′ and 44, of the robot hand is within 1.3 mm, a stroke of the rotation driving roller (40 or 40′) in the direction E is short, and a time for positioning the V notch or the like of the wafer 16 and reading the bar code and the alphameric character set is within three second. In the case of the positioning and reading by using the conventional positioning dedicated aligner, twenty or more second is required, so that an extremely great effect of shortening the processing time can be obtained.

FIG. 13 shows a specification in the case that a frequency of feeding is high and the wafer is only fed. In this specification, the structure is made such that a plurality of fingers 34 and robot arms 35 can be fed in the case that the wafer 16 being fed one by one is insufficient. A feeding capacity is increased by simultaneously feeding two stages or three stages of wafers 16 mounted on the conveyor finger 34 having multiple stages of holding portions in a vertical direction, and transferring the wafer 16 by setting the robot hands 21 to the multiple stages in the vertical direction at a time of transferring. It is possible to feed and transfer the wafer 16 double by setting the multistage type conveyor finger 34 mounting the wafer 16 thereon and the multistage type robot hand 35 to two stage type, and the capacity can be improved triple by setting them to triple stage type.

### INDUSTRIAL APPLICABILITY

As mentioned above, the present invention changes the conventional feeding of the wafers in a state of being put in the cassette or the closed box to the sheet by sheet continuous feeding, thereby making it possible to continuously supply and take out the wafers. In the batch processing method using the FOUP or the like, one of twenty five sheets in the FOUP is processed and is fed to the next step only after the remaining twenty four sheets are processed, so that the conventional system is a system having an extremely long waiting time in five hundreds and more pretreatment steps.

In accordance with the sheet feeding and transferring system on the basis of the present invention, one wafer which has been processed can be immediately fed to the next step. In accordance with the particular example with respect to the effect of the sheet feeding and transferring, the conventional batch unit feeding per unit of twenty five sheets of wafers requires twenty five days for an array step, however, it is possible to shorten to thirteen days by changing to the batch feeding per unit of thirteen sheets. Further, it is reported that the required time is shortened to 5.8 days by manually feeding the wafer sheet by the sheet. It is said that making the array step of the wafer in the sheet by sheet feeding system is an ultimate feeding system for a long time, however, there has been no particular system which can be realized in a mass production plant. The semiconductor manufacturing apparatus or the liquid crystal manufacturing apparatus is changed from the conventional job shop production system to a flow shop production system in which the semiconductor manufacturing apparatuses or the liquid crystal manufacturing apparatuses are arranged in the order of manufacturing process, owing to the present invention (in Nagasaki plant of SONY CORPORATION, the manual flow shop production system is realized). A time required for the pre-treatment process until the wafer is finished can be widely shortened by feeding the wafers sheet by sheet within the connection type EFEM of the present invention and performing the small batch feeding acceding the concept of the sheet by sheet feeding between the buffer stations, whereby it is possible to make a contribution to a reduction of construction investment cost obtained by reducing an amount of the material in manufacturing process and an amount of the finished goods in stock, and reducing a space for feeding and storing.

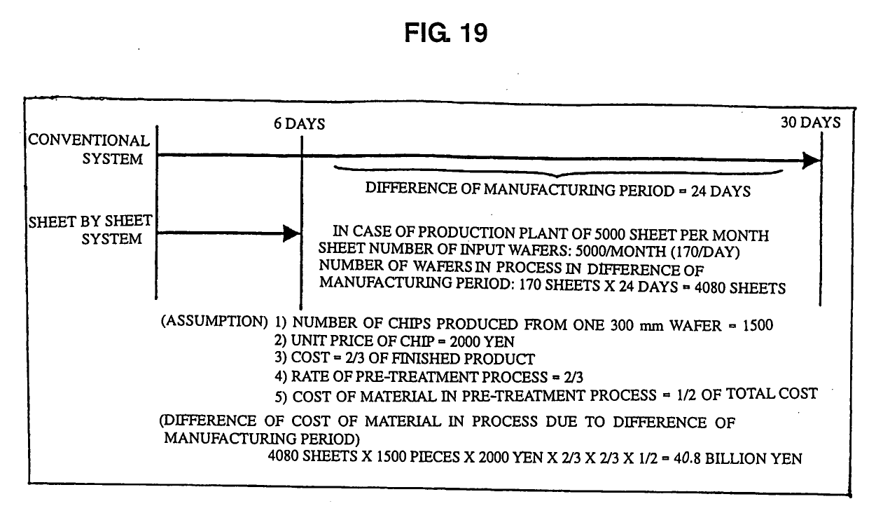

About twenty five to thirty days are currently required for manufacturing the semiconductor in the array step, however, it is said that the manufacturing days within five to six days is sufficient if the semiconductor is processed sheet by sheet as mentioned above. Since one fifth TAT and material in process are sufficient in comparison with the conventional batch system, the reduced cost of the material in process reaches some billions yen even in the plant in a comparatively small scale that 5000 sheets of wafers are produced per month, and an effect of reduction in an amount of the finished goods stock reaches such a scale as about ten billion yen, so that an extremely great effect of improving a cash flow can be obtained. FIG. 19 shows an estimation of a difference in an amount of material in process and a cost accompanying with the material in process in accordance with the production days between the production by the conventional batch system and the sheet by sheet production system. The numeric value is changed in accordance with the production number in the plant, a unit price for selling the chip and a cost rate, however, it is apparent that the production efficiency is different from a broader viewpoint. Further, in the conventional feeding by the FOUP, it is reported that an organic gas is generated from the FOUP itself due to a temperature increase within the FOUP in the case that the heat-treated wafer is put in the FOUP, thereby deteriorating a yield ratio of the products. Further, there has been developed a research that an organic gas removing apparatus is installed within the FOUP for the purpose of developing the micro sizing of the wafer process, however, since the present invention is an open air system within the clean tunnel, an organic gas countermeasure is not required. The present invention not only effectively uses the machine, but also promotes rationalization of the entire of the semiconductor production pre-treatment process, and the present invention can be immediately realized.

1. A system for sheet by sheet feeding and transferring of semiconductor or liquid crystal wafers comprising:
a sheet conveyor feeding a semiconductor or liquid crystal wafers sheet by sheet within a clean tunnel, and provided with an exhaust duct via an exhaust fan so that a dust generated due to an operation of the sheet conveyor does not affect a clean degree within the clean tunnel;
a transferring equipment connected so as to have a common clean area with said clean tunnel and transferring said semiconductor or liquid crystal wafers between said sheet conveyor and a manufacturing apparatus; and
a refilling station putting the semiconductor or the wafers in and out of an FOUP around the inside and outside of said clean area.

2. A system for sheet by sheet feeding and transferring of semiconductor or liquid crystal wafers as claimed in claim 1, wherein said transferring equipment is provided with an FOUP, an FOUP opener, a buffer cassette and a robot having a hand holding an outer peripheral edge portion of said semiconductor or liquid crystal wafer, and said robot has a finger holding the outer peripheral edge portion of said semiconductor or liquid crystal wafer, and transfers said semiconductor or liquid crystal wafer at a same speed as and in synchronous with a traveling speed of said continuously traveling sheet conveyor.

3. A system for sheet by sheet feeding and transferring of semiconductoror liquid crystal wafers as claimed in claim 1 or 2, wherein the hand of said robot is provided with a mechanism for rotating said semiconductor or liquid crystal wafer or a mechanism for rotating a part of said robot hand holding said semiconductor or liquid crystal wafer, in the case of reading a V notch or an oriental flat alignment on said semiconductor or liquid crystal wafer, or a bar code or an alphameric character set described on said semiconductor or liquid crystal wafer.

4. A system for sheet by sheet feeding and transferring of semiconductoror liquid crystal wafers as claimed in any one of claims 1 to 3, wherein said refilling station makes said semiconductor or liquid crystal wafer in a loose sheet state or a batch state, and puts said semiconductor or liquid crystal wafers fed by said sheet conveyor in said FOUP by a set optional time or a set optional sheet number.
